(19) United States
(12) Patent Application Publication
(10) Pub. No.: US 2014/0077775 A1
(43) Pub. Date: Mar. 20, 2014

(54) DIGITALLY CONTROLLED POWER SUPPLY HAVING FAILURE DETECTION FUNCTION

(71) Applicant: FANUC CORPORATION, Minamitsuru-gun (JP)

(72) Inventor: Kazuya GOTOU, Minamitsuru-gun (JP)

(73) Assignee: FANUC CORPORATION, Minamitsuru-gun (JP)

(21) Appl. No.: 14/031,419

(22) Filed: Sep. 19, 2013

(30) Foreign Application Priority Data
Sep. 20, 2012 (JP) 2012-206768

(51) Int. Cl. H02H 1/00

(52) U.S. Cl. CPC H02H 1/0007
USPC 323/234

(57) ABSTRACT

A digitally controlled power supply of the present invention comprises: a power unit outputting an output voltage, first and second feedback signals; a first A/D converter outputting a digital feedback signal and a first monitoring signal; a second A/D converter outputting a second monitoring signal; a driver outputting the gate signal; a digital controller for power supply control comprising a PWM circuit and a first failure detection signal output unit outputting a first failure detection signal when the first monitoring signal is not within a predetermined range; a digital controller for monitoring comprising a second failure detection signal output unit which outputs a second failure detection signal when the second monitoring signal is not within a predetermined range; and an alarm output unit outputting an alarm when at least either the first or second failure detection signal is output.

This application is a new U.S. patent application that claims benefit of JP 2012-206768, filed on Sep. 20, 2012, the content of JP 2012-206768 is incorporated herein by reference.

### FIELD OF THE INVENTION

The present invention relates to a digitally controlled power supply, in particular, to a digitally controlled power supply having a failure detection function.

### BACKGROUND OF THE INVENTION

A digitally controlled power supply generally includes functional blocks, such as a digital controller, a driver, and a power unit. FIG. 1 depicts a configuration example of a conventional digitally controlled power supply. Regulation operation in a conventional digitally controlled power supply 200 is as follows.

Information such as an input-output voltage, a current and a temperature of a power unit 202 is fed back to a digital controller 201 through an A/D converter 203. The digital controller 201 generates a PWM signal so that a fed back signal (power supply output) matches output voltage/current value set in the digital controller 201 based on the fed back information on the power unit 202. A driver 204 drives an FET of the power unit 202 in accordance with the generated PWM signal, and thereby converts an input voltage into an output voltage. Repeating above-described operation allows an output of a desired voltage or current.

The conventional digitally controlled power supply 200 is generally provided with a monitoring function. The monitoring function in the conventional digitally controlled power supply 200 is performed in the following procedures. First, the digitally controlled power supply 200 monitors a state of the power unit 202 using the information fed back to the digital controller 201. Next, the digitally controlled power supply 200 determines whether the monitored value is within a range set in advance. When the monitored value is not within the range set in advance, in other words, when a failure is detected, an alarm output unit 205 outputs a monitoring alarm to notify a system (not depicted), thereby notifying the system of failure occurrence in the digitally controlled power supply 200.

Note that each functional block is not necessarily independent. In other words, the digital controller 201 may include the A/D converter 203 and the driver 204, and the power unit 202 may include the driver 204.

As a digitally controlled power supply which detects a failure, a digitally controlled power supply is known which monitors a failure in calculation of an arithmetic processing circuit (a digital controller), and stops an output of an electric power supply at the time of calculation failure (for example, see Patent Literature 1).

In addition, a mutual monitor circuit is known in which an arithmetic processing circuit monitors a failure (for example, see Patent Literature 2). The circuit can detect a failure without being subject to an influence of malfunction of a microcomputer by monitoring a microcomputer's watch dog signals provided by a corresponding microcomputer.

Both conventional technologies mentioned above detect failures due to malfunction of a digital controller, but do not detect failures when a defect occurs in a feedback path.

Moreover, a multiplexed system which monitors a state of a power supply unit has been reported (for example, see Patent Literature 3). This system enables monitoring of broken power supply unit by multiplexing an overall system even when a power supply unit of a certain system fails.

Patent Literature 1: JP-A-2011-10491

Patent Literature 2: JP-A-6-119210

Patent Literature 3: JP-A-2012-70307

In a digitally controlled power supply with the above-described configuration, a case may occur in which a defect in a feedback path such as a defect of an A/D converter occurs and a state of a monitoring subject is not correctly reflected in a signal fed back to a digital controller. In such a case, since a digital controller generates a PWM signal based on the fed-back signal, there is a problem that a voltage or current as a power supply output is regulated into an unusual voltage or current which is different from an originally set value.

Further, the above-described unusual state is a state where a digital controller originally determines that an electric power source output is unusual and outputs a monitoring alarm. However, since the digital controller monitors a feedback signal currently used for the regulation, there is a problem that a digital controller makes an incorrect decision that an output voltage/current is normal and is difficult to detect a failure when there is a defect in a feedback path.

### SUMMARY OF THE INVENTION

A digitally controlled power supply of the present invention comprises: a power unit converting an input voltage based on a gate signal to output an output voltage or converting an input current based on the gate signal to output an output current, and outputting a first feedback signal and a second feedback signal; a first A/D converter outputting a digital signal for feedback and a first monitoring signal based on the first feedback signal which is primarily for regulation and is secondarily for monitoring; a second A/D converter outputting a second monitoring signal based on the second feedback signal which is primarily for the monitoring; a driver outputting the gate signal based on a PWM signal; a digital controller for power supply control comprising a PWM circuit outputting the PWM signal for controlling the power unit based on the digital signal for feedback and a first failure detection signal output unit outputting a first failure detection signal when a value of the first monitoring signal is not within a predetermined range; a digital controller for monitoring comprising a second failure detection signal output unit which outputs a second failure detection signal when a value of the second monitoring signal is not within a predetermined range; and an alarm output unit outputting an alarm when at least either the first failure detection signal or the second failure detection signal is output.

By duplexing (multiplexing) a monitoring function in a digitally controlled power supply, it is possible to notify a system that a monitoring subject is in a normal range or in a failure state even when a defect occurs in a feedback path.

In addition, even when a defect occurs in a digital controller, for example, even when a setting value such as a monitoring range of the digital controller has been changed incorrectly, it is possible to notify a system of a defect of the digital controller.

### DESCRIPTION OF THE DRAWINGS

These and other features and advantages of the present invention will be better understood by reading the following detailed description, taken together with the drawings wherein:

FIG. 1 is a schematic diagram of a conventional digitally controlled power supply;

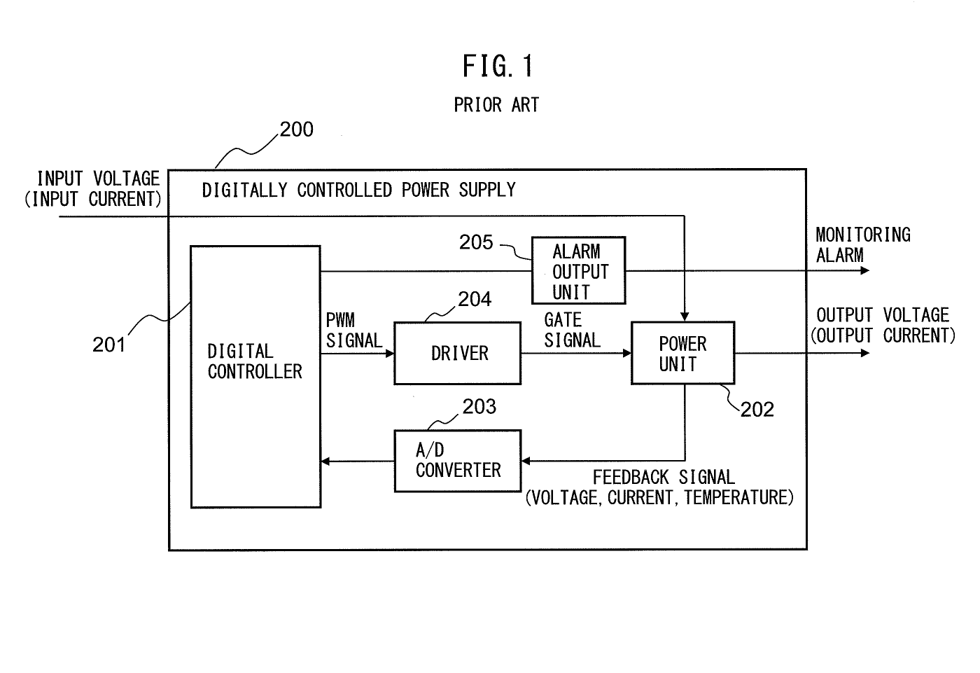

FIG. 2 is a schematic diagram of a digitally controlled power supply according to a first embodiment of the present invention;

FIG. 3 is a flowchart for illustrating operation of the digitally controlled power supply according to the first embodiment of the present invention;

FIG. 4 is a schematic diagram of a digitally controlled power supply according to a second embodiment of the present invention;

FIG. 5 is a flowchart for illustrating operation of the digitally controlled power supply according to the second embodiment of the present invention;

FIG. 6 is a schematic diagram of a digitally controlled power supply according to a third embodiment of the present invention;

FIG. 7 is a flowchart for illustrating operation of the digitally controlled power supply according to the third embodiment of the present invention;

FIG. 8 is a schematic diagram of a digitally controlled power supply according to a fourth embodiment of the present invention; and

FIG. 9 is a flowchart for illustrating operation of the digitally controlled power supply according to the fourth embodiment of the present invention.

### DETAILED DESCRIPTION OF THE PREFERRED EMBODIMENT

Hereinafter, a digitally controlled power supply according to the present invention will be illustrated with reference to drawings. However, it should be noted that the technical scope of the present invention is not limited to the embodiments thereof, and covers the invention described in the claims and equivalents thereof.

### First Embodiment

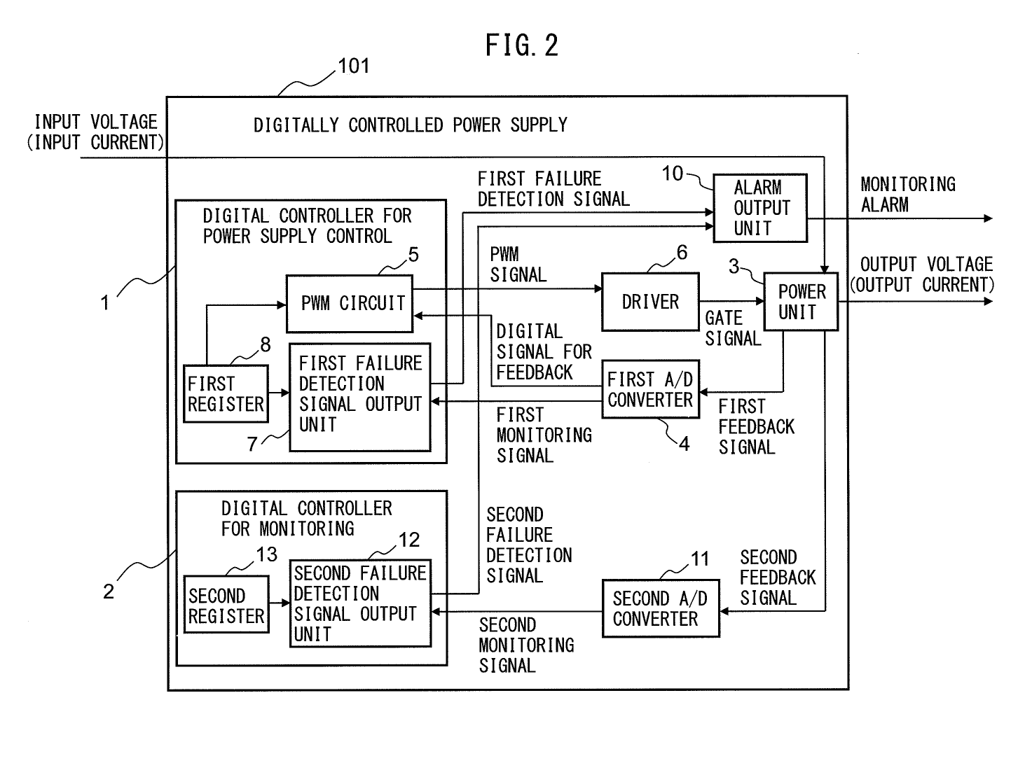

FIG. 2 is a schematic diagram of a digitally controlled power supply according to a first embodiment of the present invention. A digitally controlled power supply 101 according to the first embodiment of the present invention is characterized in that the digitally controlled power supply comprises: a power unit 3 converting an input voltage (an input current) based on a gate signal to output an output voltage (output current) and outputting first and second feedback signals; a first A/D converter 4 outputting a digital signal for feedback and a first monitoring signal based on the first feedback signal which is primarily for regulation and is secondarily for monitoring; a second A/D converter 11 outputting a second monitoring signal based on the second feedback signal which is primarily for the monitoring; a driver 6 outputting the gate signal based on a PWM signal; a digital controller for power supply control 1 comprising a PWM circuit 5 outputting the PWM signal for controlling the power unit 3 based on the digital signal for feedback and a first failure detection signal output unit 7 outputting a first failure detection signal when a value of the first monitoring signal is not within a predetermined range; a digital controller for monitoring 2 comprising a second failure detection signal output unit 12 which outputs a second failure detection signal when a value of the second monitoring signal is not within a predetermined range; and an alarm output unit 10 outputting an alarm when at least either the first failure detection signal or the second failure detection signal is output.

The digitally controlled power supply 101 according to the first embodiment of the present invention includes a circuit dedicated to monitoring which is constituted by the digital controller for monitoring 2, thereby solving a problem which occurs due to simultaneous use of a single feedback signal as a signal for regulation of a power supply and as a monitoring signal, as in a conventional digitally controlled power supply. In other words, hitherto, one digital controller performs a regulation of an electric power supply and monitoring of a power unit. On the other hand, duplexing (multiplexing) a monitoring function by further providing the digital controller for monitoring 2 and the second A/D converter 11 realizes a digitally controlled power supply which can detect a failure even when a defect occurs in a feedback path.

As depicted in FIG. 2, information such as an input-output voltage, a current and a temperature of the power unit 3 is fed back to the digital controller for power supply control 1 through the first A/D converter 4. The PWM circuit 5 provided in the digital controller for power supply control 1 generates the PWM signal so that a fed back signal (power supply output) matches an output voltage/current value set in a first register 8 based on the fed back information on the power unit 3. The driver 6 drives an FET of the power unit 3 in accordance with the generated PWM signal, thereby converting an input voltage into an output voltage. Repeating the above-described operation allows an output of a desired voltage or current.

The first failure detection signal output unit 7 provided in the digital controller for power supply control 1 monitors the state of the power unit 3 using the information fed back to the digital controller for power supply control 1. When the monitored value is not within a predetermined range which is based on a first reference value stored in advance in the first register 8, the first failure detection signal output unit 7 outputs the first failure detection signal, and the alarm output unit 10 outputs a monitoring alarm based on the first failure detection signal to notify a system.

Similarly, the second monitoring signal based on the second feedback signal is input into the digital controller for monitoring 2 from the second A/D converter 11, and the second failure detection signal output unit 12 provided in the digital controller for power supply control 1 monitors the state of the power unit 3. When the monitored value is not within a predetermined range which is based on a second reference value stored in advance in the second register 13, the second failure detection signal output unit 12 outputs the second failure detection signal, and the alarm output unit 10 outputs the monitoring alarm based on the second failure detection signal to notify a system.

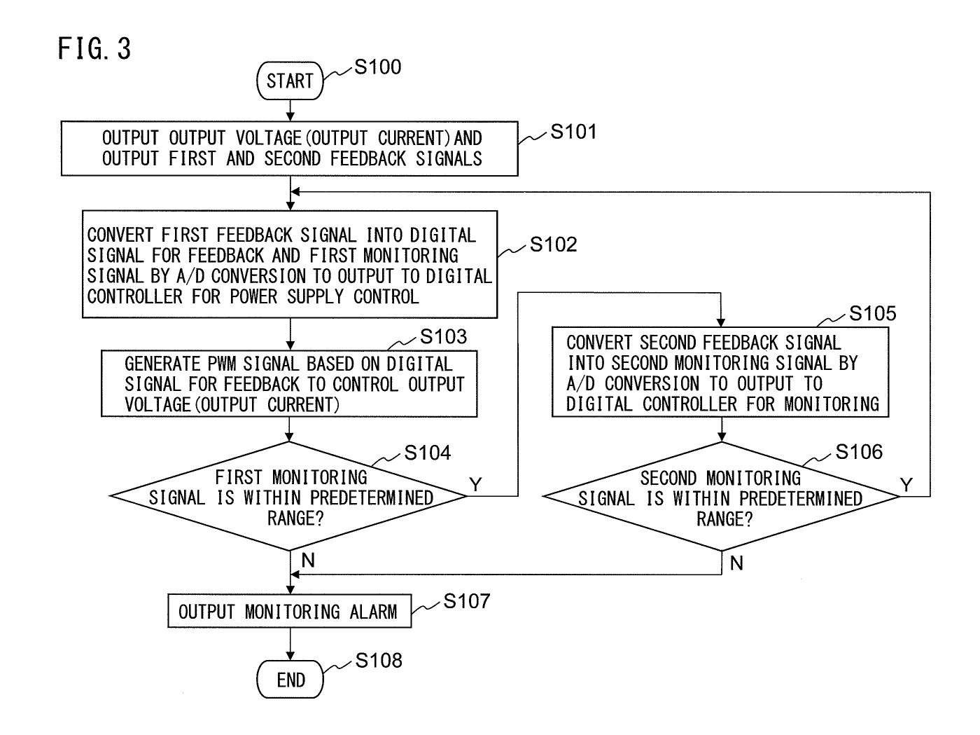

Next, operation of the digitally controlled power supply 101 according to the first embodiment of the present invention will be illustrated. FIG. 3 is a flowchart depicting operation of the digitally controlled power supply according to the first embodiment of the present invention. First, in step S101, the power unit 3 outputs the output voltage (output current) by converting the input voltage (input current) which is input into the digitally controlled power supply 101 based on the gate signal, and outputs first and second feedback signals. The first and second feedback signals include a signal regarding a voltage, a current, a temperature or the like. The first and second feedback signals output from the power unit 3 are input into the first A/D converter 4 and the second A/D converter 11, respectively.

Next, in step S102, the first A/D converter 4 converts the first feedback signal into a digital signal for feedback and a first monitoring signal by A/D conversion, and outputs the signals to the digital controller for power supply control 1. Specifically, the digital signal for feedback is output to the PWM circuit 5 provided in the digital controller for power supply control 1, and the first monitoring signal is output to the first failure detection signal output unit 7 provided in the digital controller for power supply control 1.

Next, in step S103, the PWM circuit 5 generates the PWM signal based on the digital signal for feedback to control the output voltage (output current) output from the power unit 3.

Next, in step S104, the first failure detection signal output unit 7 compares the first monitoring signal with the first reference value stored in the first register 8 to determine whether or not the first monitoring signal is within a predetermined range which is based on the first reference value. When the first monitoring signal is not within the predetermined range, the first failure detection signal is output to the alarm output unit 10 from the first failure detection signal output unit 7 and the alarm output unit 10 outputs the monitoring alarm in step S107. On the other hand, when the first monitoring signal is within the predetermined range, a double monitoring according to the digital controller for monitoring 2 is performed as follows.

In step S105, the second A/D converter 11 converts the second feedback signal into a second monitoring signal by A/D conversion, and outputs the converted signal to the digital controller for monitoring 2. Specifically, the second monitoring signal is output to the second failure detection signal output unit 12 provided in the digital controller for monitoring 2.

Next, in step S106, the second failure detection signal output unit 12 compares the second monitoring signal with the second reference value stored in the second register 13 to determine whether or not the second monitoring signal is within a predetermined range which is based on the second reference value. When the second monitoring signal is not within the predetermined range, the second failure detection signal is output to the alarm output unit 10 from the second failure detection signal output unit 12 and the alarm output unit 10 outputs the monitoring alarm in step S107. On the other hand, when the second monitoring signal is within the predetermined range, the process returns to step S102 and stabilization of the output of power unit 3 and the monitoring of the first and second feedback signals are continued. The double monitoring of the feedback signal by the digital controller for monitoring 2 is performed in above-described manner.

As illustrated above, in the digitally controlled power supply according to the first embodiment, by duplexing the circuit which detects the failure of the feedback signal by two failure detection signals converted through two A/D converters based on the feedback signals from the power unit, the failure of the digitally controlled power supply can be detected by one failure detection circuit even when a defect occurs in the other failure detection circuit.

Although the present embodiment illustrates the configuration which performs double monitoring of the general feedback signal, it is not limited to this configuration and it is also possible to multiplex the monitoring to be triple monitoring or more.

### Second Embodiment

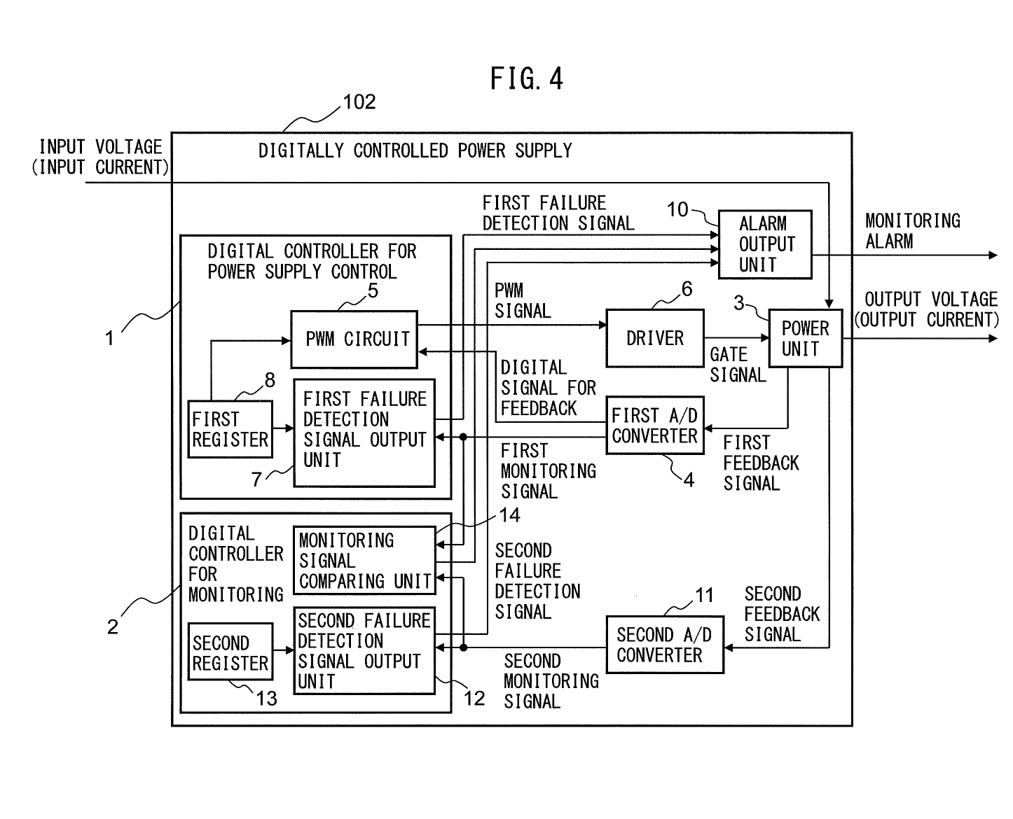

Next, a digitally controlled power supply according to a second embodiment of the present invention will be illustrated. FIG. 4 is a schematic diagram of the digitally controlled power supply according to the second embodiment of the present invention. A digitally controlled power supply 102 according to the second embodiment of the present invention is different from the digitally controlled power supply 101 according to the first embodiment in that: the digital controller for monitoring 2 further includes a monitoring signal comparing unit 14 calculating a difference of the monitoring signals which is a difference between a value of the first monitoring signal and a value of the second monitoring signal, and outputting a third failure detection signal when the difference of the monitoring signals is not within a predetermined range; and the alarm output unit 10 outputs the alarm when at least one of the first failure detection signal, the second failure detection signal and the third failure detection signals is output. The other components are the same as the components in the first embodiment, and therefore redundant illustration is omitted.

Even in the configuration of the first embodiment, when a defect occurs in the digital controller, for example, at the time of hang-up, there is a possibility that the digitally controlled power supply may not be able to detect a failure. Therefore, the digitally controlled power supply according to the second embodiment monitors the feedback (monitoring) signals for the digital controllers, and outputs the monitoring alarm when the difference between the signals exceeds a range set in advance.

According to this configuration, for example, when a defect occurs in operation of the first failure detection signal output unit 7 itself though the first monitoring signal is in an unusual range, the monitoring signal comparing unit 14 compares the first monitoring signal with the second monitoring signal, and thereby it becomes possible to determine that it is unusual when the difference between the first monitoring signal and the second monitoring signal is not within a predetermined range which is set in advance in the monitoring signal comparing unit 14.

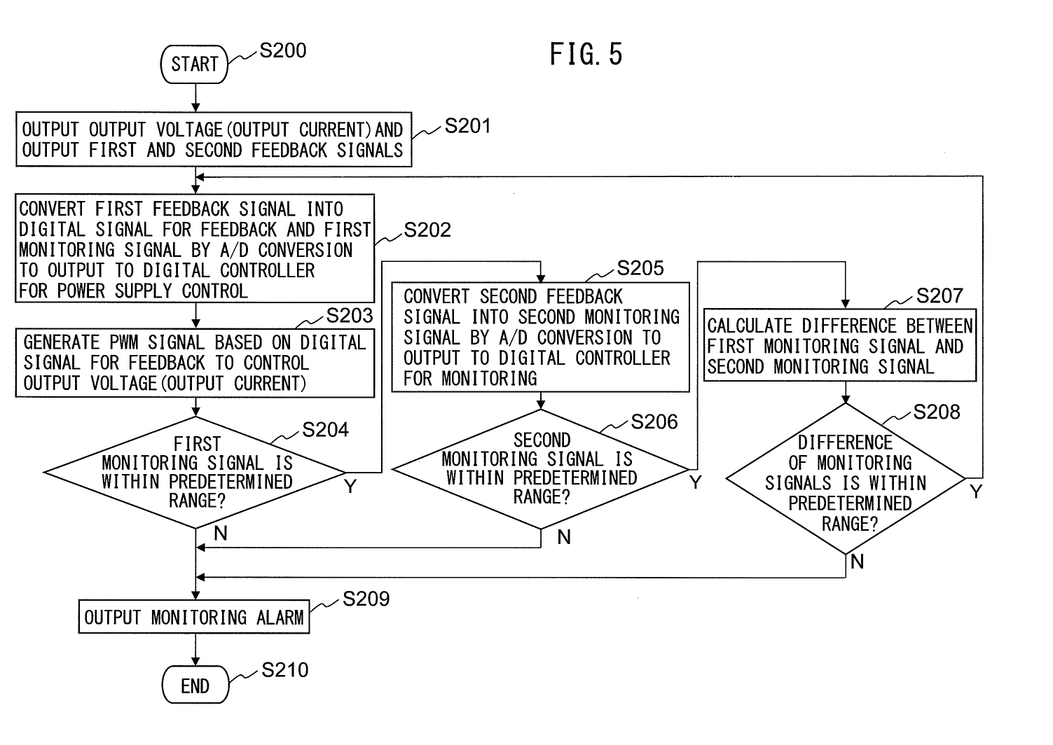

Next, operation of the digitally controlled power supply 102 according to the second embodiment of the present invention will be illustrated. FIG. 5 is a flowchart depicting operation of the digitally controlled power supply according to the second embodiment of the present invention. The operation of steps S201 to S205 is the same as the operation of step S101 to S105 in the flowchart of FIG. 3 which depicts the operation of the digitally controlled power supply according to the first embodiment, and therefore redundant illustration is omitted.

When the second monitoring signal is within a predetermined range in step S206, feedback as the first embodiment is not continued but the monitoring is still performed in step S207. In step S207, the monitoring signal comparing unit 14 provided in the digital controller for monitoring 2 calculates the difference of the monitoring signals which is the difference between the value of the first monitoring signal and the value of the second monitoring signal.

Next, in step S208, the monitoring signal comparing unit 14 determines whether or not the difference of the monitoring signals is within the predetermined range which is set in advance in the monitoring signal comparing unit 14. When the difference of the monitoring signal is not within the predetermined range, the third failure detection signal is output to the alarm output unit 10 in step S209, and the alarm output unit 10 outputs the monitoring alarm. On the other hand, when the difference of the monitoring signal is within the predetermined range, the process returns to step S202 and stabilization of the output of power unit 3 and the monitoring of the first and second feedback signals are continued.

By providing the second failure detection signal output unit 12 and the monitoring signal comparing unit 14 in the digital controller for monitoring 2 as described above, the alarm output unit 10 is made to output an alarm when at least one of the first failure detection signal, the second failure detection signal and the third failure detection signals is output, and thereby the monitoring of the feedback signal can be multiplexed.

### Third Embodiment

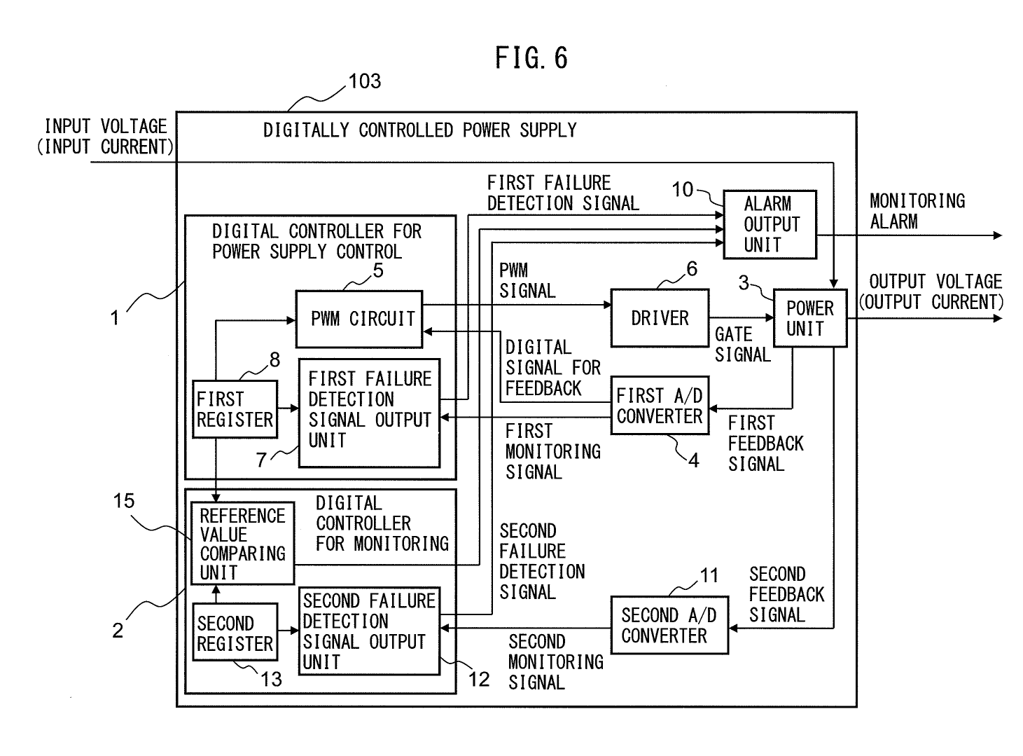

Next, a digitally controlled power supply according to a third embodiment of the present invention will be illustrated. FIG. 6 is a schematic diagram of the digitally controlled power supply according to the third embodiment of the present invention. A digitally controlled power supply 103 according to the third embodiment of the present invention is different from the digitally controlled power supply 101 according to the first embodiment in that: the digital controller for power supply control 1 includes a first register 8 which stores a first reference value used as the criterion of the first monitoring signal; the digital controller for monitoring 2 further includes a second register 13 which stores a second reference value used as the criterion of the second monitoring signal and a reference value comparing unit 15 which calculates a difference of the reference values which is the difference between the first reference value and the second reference value and outputs a fourth failure detection signal when the difference of the reference values is not within a predetermined range; and the alarm output unit 10 outputs the alarm when at least one of the first failure detection signal, the second failure detection signal and the fourth failure detection signals is output. The other components are the same as the components in the first embodiment, and therefore redundant illustration is omitted.

Even in the configuration of the first embodiment, when a defect occurs in the digital controller, for example, when any of setting values, for example those for monitored values of the digital controllers, have been changed incorrectly, there is a possibility that the digitally controlled power supply may not be able to detect a failure. Therefore, the digitally controlled power supply according to the third embodiment monitors the setting values, for example those for monitoring ranges, of the digital controllers, and outputs the monitoring alarm when the difference between the setting values exceeds a range set in advance.

According to this configuration, for example, when a defect occurs in operation of the first register 8 itself though the first monitoring signal is in an unusual range, the reference value comparing unit 15 compares the first reference value stored in the first register 8 with the second reference value stored in the second register 13, and thereby it becomes possible to determine that it is unusual when the difference is not within a predetermined range which is set in advance in the reference value comparing unit 15.

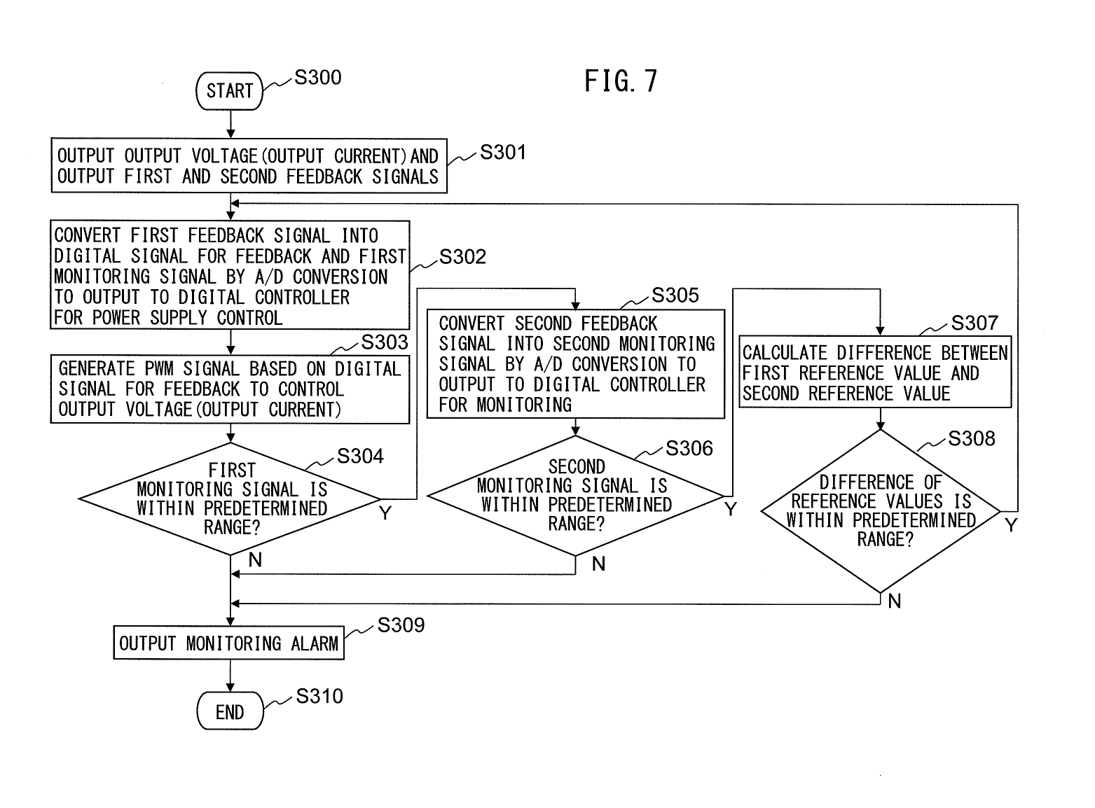

Next, operation of the digitally controlled power supply 103 according to the third embodiment of the present invention will be illustrated. FIG. 7 is a flowchart depicting operation of the digitally controlled power supply according to the third embodiment of the present invention. The operation of steps S301 to S305 is the same as the operation of steps S101 to S105 in the flowchart of FIG. 3 which depicts the operation of the digitally controlled power supply according to the first embodiment, and therefore redundant illustration is omitted.

When the second monitoring signal is within a predetermined range in step S306, feedback as in the first embodiment is not continued but the monitoring is still performed in step S307. In step S307, the reference value comparing unit 15 provided in the digital controller for monitoring 2 calculates the difference of the reference values which is the difference between the first reference value and the second reference value.

Next, in step S308, the reference value comparing unit 15 determines whether or not the difference of the reference values is within the predetermined range which is set in advance in the reference value comparing unit 15. When the difference of the reference values is not within the predetermined range, in step S309, the fourth failure detection signal is output to the alarm output unit 10, and the alarm output unit 10 outputs a monitoring alarm. On the other hand, when the reference value is within the predetermined range, the process returns to step S302 and stabilization of the output of power unit 3 and the monitoring of the first and second feedback signals are continued.

By providing the second failure detection signal output unit 12 and the reference value comparing unit 15 in the digital controller for monitoring 2 as described above, the alarm output unit 10 is made to output an alarm when at least one of the first failure detection signal, the second failure detection signal and the fourth failure detection signals is output, and thereby the monitoring of the feedback signal can be multiplexed.

### Fourth Embodiment

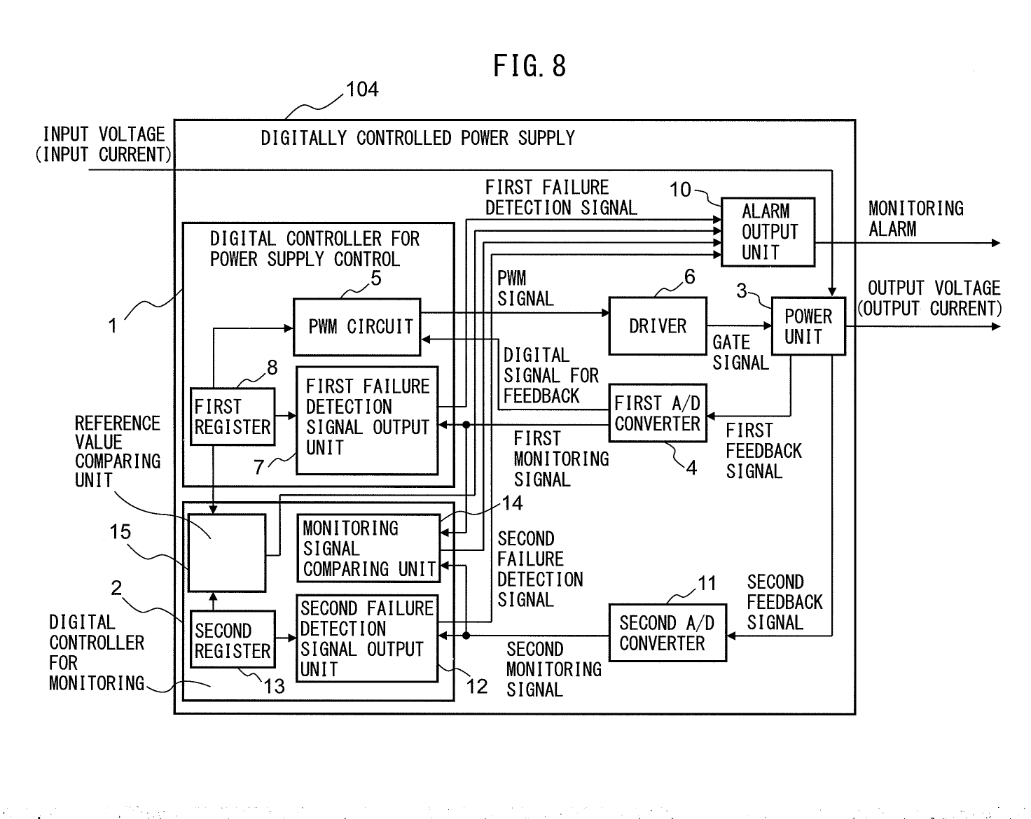

Next, a digitally controlled power supply according to a fourth embodiment of the present invention will be illustrated. FIG. 8 is a schematic diagram of a digitally controlled power supply according to the fourth embodiment of the present invention. A digitally controlled power supply 104 according to the fourth embodiment of the present invention is different from the digitally controlled power supply 101 according to the first embodiment in that: the digital controller for power supply control 1 further includes a first register 8 which stores a first reference value used as the criterion of the first monitoring signal; the digital controller for monitoring 2 includes a monitoring signal comparing unit 14 calculating a difference of the monitoring signals which is the difference of a value of a first monitoring signal and a value of the second monitoring signal and outputting a third failure detection signal when the difference of the monitoring signals is not within a predetermined range, a second register 13 which stores a second reference value used as the criterion of the second monitoring signal, and a reference value comparing unit 15 calculating a difference of the reference values which is the difference between the first reference value and the second reference value and outputting a fourth failure detection signal when the difference of the reference values is not within a predetermined range; and the alarm output unit 10 outputs the alarm when at least one of the first to fourth failure detection signals is output. The other components are the same as the components in the first embodiment, and therefore redundant illustration is omitted.

Even in the configuration of the first embodiment, when a defect occurs in the digital controller, for example, at the time of hang-up or when any setting values, for example those for monitored values of the digital controllers, have been changed incorrectly, there is a possibility that the digitally controlled power supply may not be able to detect a failure. Therefore, the digitally controlled power supply according to the fourth embodiment monitors the feedback (monitoring) signals for the digital controllers and monitors the setting values, for example those for monitoring ranges, of the digital controllers, and outputs the monitoring alarm when any of the difference of signals and the difference of values exceeds a range set in advance.

According to such configuration, for example, when a defect occurs in operation of the first failure detection signal output unit 7 itself though the first monitoring signal is in an unusual range, the monitoring signal comparing unit 14 compares the first monitoring signal with the second monitoring signal, and thereby it becomes possible to determine that it is unusual when the difference therebetween is not within a predetermined range. Further, for example, when a defect occurs in operation of the first register 8 itself though the first monitoring signal is in an unusual range, the reference value comparing unit 15 compares the first reference value stored in the first register 8 with the second reference value stored in the second register 13, and thereby it becomes possible to determine that it is unusual when the difference therebetween is not within a predetermined range.

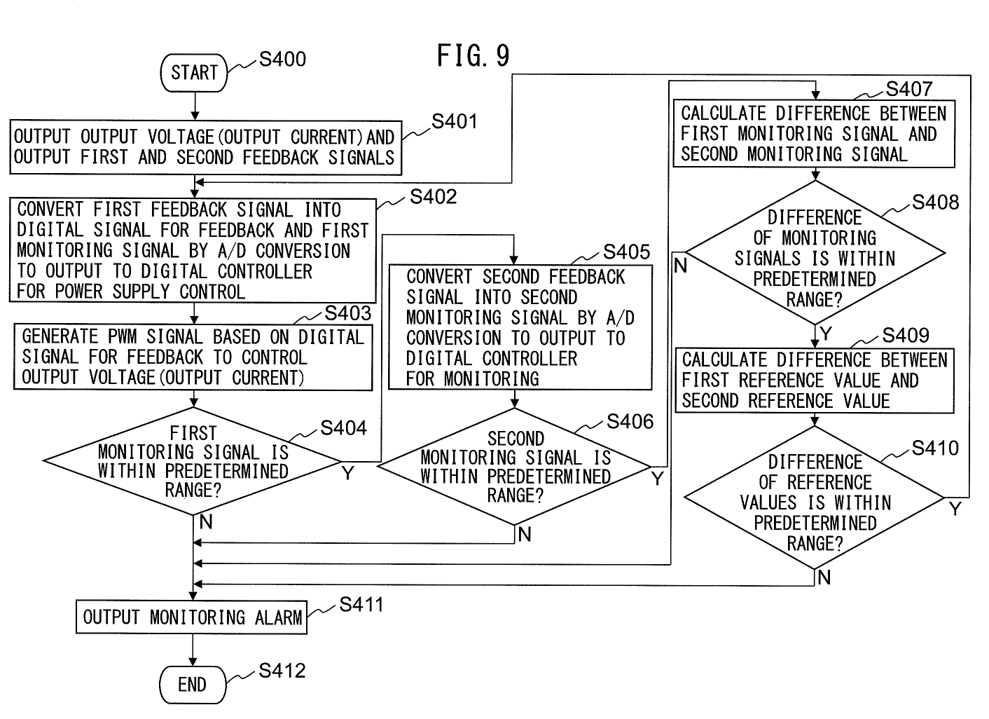

Next, operation of the digitally controlled power supply 104 according to the fourth embodiment of the present invention will be illustrated. FIG. 9 is a flowchart depicting operation of the digitally controlled power supply according to the fourth embodiment of the present invention. The operation of steps S401 to S405 is the same as the operation of steps S101 to S105 in the flowchart of FIG. 3 which depicts the operation of the digitally controlled power supply according to the first embodiment, and therefore redundant illustration is omitted.

When the second monitoring signal is within the predetermined range in step S406, feedback as the first embodiment is not continued but the monitoring is still performed in step S407. In step S407, the monitoring signal comparing unit 14 provided in the digital controller for monitoring 2 calculates the difference of the monitoring signals which is the difference between the value of the first monitoring signal and the value of the second monitoring signal.

Next, in step S408, the monitoring signal comparing unit 14 determines whether or not the difference of the monitoring signals is within the predetermined range which is set in advance in the monitoring signal comparing unit 14. When the difference of the monitoring signals is not within the predetermined range, in step S411, the third failure detection signal is output to the alarm output unit 10, and the alarm output unit 10 outputs the monitoring alarm. On the other hand, when the difference of the monitoring signals is within the predetermined range, the monitoring is still performed in step S409. In step S409, the reference value comparing unit 15 provided in the digital controller for monitoring 2 calculates the difference of the reference values which is the difference between the first reference value and the second reference value.

Next, in step S410, the reference value comparing unit 15 determines whether or not the difference of the reference values is within a predetermined range which is set in advance in the reference value comparing unit 15. When the difference of the reference values is not within the predetermined range, in step S411, the fourth failure detection signal is output to the alarm output unit 10, and the alarm output unit 10 outputs the monitoring alarm. On the other hand, when the difference of the reference values is within the predetermined range, the process returns to step S402 and stabilization of the output of power unit 3 and the monitoring of the first and second feedback signals are continued.

By providing the second failure detection signal output unit 12, the monitoring signal comparing unit 14 and the reference value comparing unit 15 in the digital controller for monitoring 2 as described above, the alarm output unit 10 is made to output an alarm when at least one of the first to fourth failure detection signals is output, and thereby the monitoring can be multiplexed.

The embodiments of the present invention illustrated above provide configurations in which one digital controller for monitoring is provided to one digital controller for power supply control. However, the present invention is not limited to such manner, but a plurality of digital controllers for monitoring may be provided to one digital controller for power supply control.

What is claimed is:

1. A digitally controlled power supply comprising:
a power unit converting an input voltage based on a gate signal to output an output voltage or converting an input current based on the gate signal to output an output current, and outputting a first feedback signal and a second feedback signal;
a first A/D converter outputting a digital signal for feedback and a first monitoring signal based on the first feedback signal which is primarily for regulation and is secondarily for monitoring;
a second A/D converter outputting a second monitoring signal based on the second feedback signal which is primarily for the monitoring;
a driver outputting the gate signal based on a PWM signal;
a digital controller for power supply control comprising a PWM circuit outputting the PWM signal for controlling the power unit based on the digital signal for feedback and a first failure detection signal output unit outputting a first failure detection signal when a value of the first monitoring signal is not within a predetermined range;
a digital controller for monitoring comprising a second failure detection signal output unit which outputs a second failure detection signal when a value of the second monitoring signal is not within a predetermined range; and
an alarm output unit outputting an alarm when at least either the first failure detection signal or the second failure detection signal is output.

2. The digitally controlled power supply according to claim 1, wherein
the digital controller for monitoring further comprises a monitoring signal comparing unit calculating a difference of the monitoring signals which is the difference of the value of the first monitoring signal and the value of the second monitoring signal, and outputting a third failure detection signal when the difference of monitoring signals is not within a predetermined range, and
the alarm output unit outputs the alarm when at least one of the first failure detection signal, the second failure detection signal and the third failure detection signals is output.

3. The digitally controlled power supply according to claim 1, wherein
the digital controller for power supply control further comprises a first register storing a first reference value used as the criterion of the first monitoring signal,
the digital controller for monitoring further comprises a second register storing a second reference value used as the criterion of the second monitoring signal, and a reference value comparing unit calculating a difference of the reference values which is a difference between the first reference value and the second reference value and outputting a fourth failure detection signal when the difference of the reference values is not within a predetermined range, and
the alarm output unit outputs the alarm when at least one of the first failure detection signal, the second failure detection signal and the fourth failure detection signals is output.

4. The digitally controlled power supply according to claim 1, wherein
the digital controller for power supply control further comprises a first register storing a first reference value used as the criterion of the first monitoring signal,
the digital controller for monitoring further comprises: a monitoring signal comparing unit calculating a difference of the monitoring signals which is the difference of the value of the first monitoring signal and the value of the second monitoring signal and outputting a third failure detection signal when the difference of the monitoring signal is not within a predetermined range; a second register storing a second reference value used as the criterion of the second monitoring signal; and a reference value comparing unit calculating a difference of the reference values which is a difference between the first reference value and the second reference value and outputting a fourth failure detection signal when the difference of the reference values is not within a predetermined range, and
the alarm output unit outputs the alarm when at least one of first to fourth failure detection signals is output.
